(19) United States
(12) Patent Application Publication
(10) Pub. No.: US 2025/0187562 A1
(43) Pub. Date: Jun. 12, 2025

(54) ELECTRONIC DEVICE AND METHOD FOR CONTROLLING THE SAME

(71) Applicants: HYUNDAI MOTOR COMPANY, Seoul (KR); Kia Corporation, Seoul (KR)

(72) Inventor: Dae Hyun KIM, Seoul (KR)

(73) Assignees: HYUNDAI MOTOR COMPANY, Seoul (KR); Kia Corporation, Seoul (KR)

(21) Appl. No.: 18/734,093

(22) Filed: Jun. 5, 2024

(30) Foreign Application Priority Data
Dec. 12, 2023 (KR) 10-2023-0180178

(51) Int. Cl. B60R 25/34; G07C 5/02; H04L 9/40

(52) U.S. Cl. CPC B60R 25/34; G07C 5/02; H04L 63/0823

(57) ABSTRACT

In an electronic device including a memory that stores computer-executable instructions, and at least one processor that accesses the memory and execute the instructions, the at least one processor identifies, from a third-party autonomous driving module, at least one of a software version of the third-party autonomous driving module or identification information of the third-party autonomous driving module, or any combination thereof, outputs a test scenario related to autonomous driving based on a certificate of the third-party autonomous driving module being verified as at least one of the software version or the identification information, or any combination thereof is transmitted to a certificate management server, and is configured to perform routing of a gateway of the third-party autonomous driving module and the vehicle based on the test scenario and a control signal of the third-party autonomous driving module corresponding to the test scenario.

### CROSS-REFERENCE TO RELATED APPLICATION

The present application claims priority to Korean Patent Application No. 10-2023-0180178, filed on Dec. 12, 2023, the entire contents of which is incorporated herein for all purposes by this reference.

### BACKGROUND OF THE PRESENT DISCLOSURE

### Field of the Present Disclosure

The present disclosure relates to an electronic device and a control method, and more particularly, to a technology for authentication and performance verification of a third-party autonomous driving module.

### Description of Related art

A third-party autonomous driving module is a module that allows a vehicle to move by transmitting commands from an external system of the vehicle to an internal system. For example, the third-party autonomous driving module may generate autonomous driving data that allows the vehicle to move based on data obtained from devices such as a camera, a radio detection and ranging (RADAR), and a Light Detection and Ranging (LiDAR), and transmit a control signal related thereto to the vehicle.

The third-party autonomous driving module may have characteristics of being able to be developed by manufacturers other than a vehicle manufacturer, rather than being manufactured by the vehicle manufacturer. Because of such characteristics, connection of the third-party autonomous driving module and the vehicle may include a security issue of being hacked from the outside thereof.

An unauthorized third-party autonomous driving module may be connected to the vehicle. This may cause a failure, a malfunction, and the like of the vehicle, which may include a potential to cause an accident of the vehicle and pose a threat to a driver's life. Additionally, a performance of an authorized third-party autonomous driving modules is not able to be guaranteed.

To solve such problems, it is necessary to develop a technology that is configured to perform authentication and performance verification of the third-party autonomous driving module.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electronic device and a control method which may use a pre-authorized third-party autonomous driving module and prevent a failure and a malfunction of a vehicle caused by the third-party autonomous driving module by identifying software version and identification information from the third-party autonomous driving module and verifying a certificate via a certificate management server.

Another aspect of the present disclosure provides an electronic device and a control method which may perform routing of a gateway of a third-party autonomous driving module that has been authorized in advance and whose autonomous driving performance has been verified and a vehicle by comparing a test scenario with a control signal of the third-party autonomous driving module based on a certificate being verified.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an electronic device includes a memory that stores computer-executable instructions, and at least one processor that accesses the memory and execute the instructions, and the at least one processor identifies, from a third-party autonomous driving module, at least one of a software version of the third-party autonomous driving module or identification information of the third-party autonomous driving module, or any combination thereof, outputs a test scenario related to autonomous driving based on a certificate of the third-party autonomous driving module being verified as at least one of the software version or the identification information, or any combination thereof is transmitted to a certificate management server, and is configured to perform routing of a gateway of the third-party autonomous driving module and a vehicle based on the test scenario and a control signal of the third-party autonomous driving module corresponding to the test scenario.

In an exemplary embodiment of the present disclosure, the at least one processor may identify at least one of the software version or the identification information, or any combination thereof from the third-party autonomous driving module based on the vehicle and the third-party autonomous driving module being connected to each other, and disconnect the vehicle and the third-party autonomous driving module from each other based on at least one of the software version or the identification information, or any combination thereof not being identified.

In an exemplary embodiment of the present disclosure, the at least one processor is configured to transmit a message related to a certificate issuance request to the third-party autonomous driving module based on the verification of the certificate being failed.

In an exemplary embodiment of the present disclosure, the at least one processor may obtain a transaction record corresponding to the certificate from a blockchain stored in the certificate management server, and verify the certificate based on at least one of the transaction record, the identification information, or a model information of the vehicle, or any combination thereof.

In an exemplary embodiment of the present disclosure, the at least one processor may identify driving information related to an image-based advanced driver assistance system (ADAS) and road information of a predetermined road section, identify a traffic scenario related to the autonomous driving of the vehicle based on the driving information and the road information, generate the test scenario based on the driving information, the road information, and the traffic scenario, and output the test scenario to the third-party autonomous driving module.

In an exemplary embodiment of the present disclosure, the at least one processor is configured to generate a correct answer signal for the test scenario, obtain result data via comparison between the correct answer signal and the control signal based on the control signal being received from the third-party autonomous driving module, and perform the routing of the gateway of the third-party autonomous driving module and the vehicle based on the result data and a predetermined threshold value.

In an exemplary embodiment of the present disclosure, the at least one processor is configured to stop the routing of the gateway of the third-party autonomous driving module and the vehicle based on the result data being smaller than the predetermined threshold value.

In an exemplary embodiment of the present disclosure, the software version may include a version of software running the third-party autonomous driving module, the identification information may include information allowing the vehicle to identify the third-party autonomous driving module, and the certificate may include information on authorization for the third-party autonomous driving module to control the vehicle by the certificate management server.

According to another aspect of the present disclosure, a control method includes identifying, from a third-party autonomous driving module, at least one of a software version of the third-party autonomous driving module or identification information of the third-party autonomous driving module, or any combination thereof, outputting a test scenario related to autonomous driving based on a certificate of the third-party autonomous driving module being verified as at least one of the software version or the identification information, or any combination thereof is transmitted to a certificate management server, and performing routing of a gateway of the third-party autonomous driving module and the vehicle based on the test scenario and a control signal of the third-party autonomous driving module corresponding to the test scenario.

In an exemplary embodiment of the present disclosure, the identifying of the at least one of the software version or the identification information, or any combination thereof may include identifying at least one of the software version or the identification information, or any combination thereof from the third-party autonomous driving module based on the vehicle and the third-party autonomous driving module being connected to each other, and disconnecting the vehicle and the third-party autonomous driving module from each other based on at least one of the software version or the identification information, or any combination thereof not being identified.

In an exemplary embodiment of the present disclosure, the outputting of the test scenario related to the autonomous driving may include transmitting a message related to a certificate issuance request to the third-party autonomous driving module based on the verification of the certificate being failed.

In an exemplary embodiment of the present disclosure, the outputting of the test scenario related to the autonomous driving may include obtaining a transaction record corresponding to the certificate from a blockchain stored in the certificate management server, and verifying the certificate based on at least one of the transaction record, the identification information, or a model information of the vehicle, or any combination thereof.

In an exemplary embodiment of the present disclosure, the outputting of the test scenario related to the autonomous driving may include identifying driving information related to an image-based advanced driver assistance system (ADAS) and road information of a predetermined road section, identifying a traffic scenario related to the autonomous driving of the vehicle based on the driving information and the road information, generating the test scenario based on the driving information, the road information, and the traffic scenario, and outputting the test scenario to the third-party autonomous driving module.

In an exemplary embodiment of the present disclosure, the performing of the routing of the gateway of the third-party autonomous driving module and the vehicle may include generating a correct answer signal for the test scenario, obtaining result data via comparison between the correct answer signal and the control signal based on the control signal being received from the third-party autonomous driving module, and performing the routing of the gateway of the third-party autonomous driving module and the vehicle based on the result data and a predetermined threshold value.

In an exemplary embodiment of the present disclosure, the performing of the routing of the gateway of the third-party autonomous driving module and the vehicle may include stopping the routing of the gateway of the third-party autonomous driving module and the vehicle based on the result data being smaller than the predetermined threshold value.

In an exemplary embodiment of the present disclosure, the software version may include a version of software running the third-party autonomous driving module, the identification information may include information allowing the vehicle to identify the third-party autonomous driving module, and the certificate may include information on authorization for the third-party autonomous driving module to control the vehicle by the certificate management server.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an electronic device according to an exemplary embodiment of the present disclosure;

FIG. 2 is a flowchart illustrating a method for verifying a third-party autonomous driving module according to an exemplary embodiment of the present disclosure;

FIG. 3 is a diagram showing a connection relationship with a third-party autonomous driving module of an electronic device according to an exemplary embodiment of the present disclosure;

FIG. 4 is a flowchart illustrating a method for verifying a certificate and executing a test scenario by an electronic device according to an exemplary embodiment of the present disclosure;

FIG. 5 is a flowchart illustrating a method for performing gateway routing based on a test scenario by an electronic device according to an exemplary embodiment of the present disclosure; and

FIG. 6 is a diagram illustrating a computing system related to an electronic device or a control method according to an exemplary embodiment of the present disclosure.

In relation to a description of the drawings, the same or similar reference numerals may be used for the same or similar components.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure. Various embodiments of the present specification are described with reference to the accompanying drawings. However, this is not intended to limit the technology described herein to specific embodiments, and should be understood to include various modifications, equivalents, and/or alternatives to the exemplary embodiments of the present specification. In connection with the description of the drawings, similar reference numerals may be used for similar components.

In describing the components of the exemplary embodiment of the present disclosure, terms such as first, second, A, B, (a), (b), and the like may be used. These terms are merely intended to distinguish the components from other components, and the terms do not limit the nature, order or sequence of the components. Furthermore, unless otherwise defined, all terms including technical and scientific terms used herein include the same meaning as commonly understood by one of ordinary skill in the art to which the present disclosure belongs. It will be further understood that terms, such as those defined in commonly used dictionaries, should be interpreted as having a meaning which is consistent with their meaning in the context of the relevant art and will not be interpreted in an idealized or overly formal sense unless expressly so defined herein. For example, expressions such as “first”, “second”, and the like used herein may modify various components regardless of order and/or importance, and are only used to distinguish one component from another component and do not limit the corresponding components. For example, a first user device and a second user device may represent different user devices regardless of the order or the importance. For example, a first component may be renamed a second component without departing from the scope of rights described herein, and similarly, the second component may also be renamed the first component.

As used herein, expressions such as “have”, “may have”, “include”, or “may include” refer to corresponding features (e.g., values, functions, operations, or components such as parts), and do not exclude the presence of additional features.

When one component (e.g., the first component) is referred to as being “(operatively or communicatively) coupled with/to” or “connected to” another component (e.g., the second component), it should be understood that the one component may be directly connected to said another component or may be connected thereto via a yet another component (e.g., a third component). On the other hand, when one component (e.g., the first component) is referred to as being “directly connected to” or “directly coupled to” another component (e.g., the second component), it may be understood that no other component (e.g., the third component) exists between the one component and said another component.

An expression “configured to” used in the present specification may be used interchangeably with, for example, “suitable for”, “having the capacity to”, “designed to”, “adapted to”, “made to”, or “capable of”, depending on a situation.

The term “configured (or set) to” may not necessarily mean “specifically designed to” in hardware. Instead, in some situations, an expression “device configured to ˜” may mean that the device is “capable of ˜” with other devices or components. For example, a phrase “processor configured (or set) to perform A, B, and C” may refer to a dedicated processor (e.g., an embedded processor) to perform the corresponding operations, or a generic-purpose processor (e.g., a CPU or an application processor) which may perform the corresponding operations by executing one or more software programs stored on a memory device. Terms used in the present specification are only used to describe a specific embodiment, and may not be intended to limit the scope of other embodiments. Singular expressions may include plural expressions, unless the context clearly indicates otherwise. Terms used herein, including technical or scientific terms, may include the same meaning as commonly understood by a person of ordinary skill in the field of the present disclosure described in the present specification. Among the terms used in the present specification, terms defined in general dictionaries may be interpreted to include the same or similar meanings as the meanings they have in the context of related technology, and unless clearly defined in the present specification, may not be interpreted as ideal or excessively formal meanings. In some cases, even the terms defined in the present specification are not able to be interpreted to exclude embodiments of the present specification.

In the present specification, expressions such as “A or B”, “at least one of A or/and B”, or “one or more of A or/and B” may include all possible combinations of the items listed together. For example, “A or B”, “at least one of A and B”, or “at least one of A or B” may refer to all cases of (1) including at least one A, (2) including at least one B, or (3) including both at least one A and at least one B. Additionally, in describing the components of the exemplary embodiment of the present disclosure, each of phrases such as “A or B”, “at least one of A and B”, “at least one of A or B”, “A, B, or C”, “A, B, and C”, “at least one of A, B, or C”, and “at least one of A, B, or C, or any combination thereof” may include any one of the items listed together in the corresponding phrase, or any possible combination thereof. the phrase such as “at least one of A, B, or C, or any combination thereof” may include A or B or C or a combination thereof such as AB or ABC.

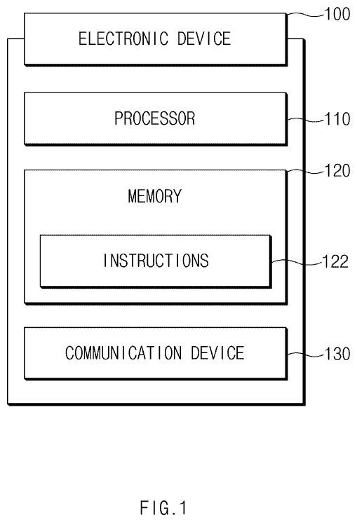

Hereinafter, various exemplary embodiments of the present disclosure will be described in detail with reference to FIGS. 1 to 6.

FIG. 1 is a diagram illustrating an electronic device according to an exemplary embodiment of the present disclosure.

An electronic device 100 according to various exemplary embodiments of the present disclosure may include a processor 110, a memory 120 including instructions 122, and a communication device 130.

The electronic device 100 may represent a device that verifies a third-party autonomous driving module. For example, electronic device 100 may be a device that verifies a certificate of the third-party autonomous driving module and verifies a performance of the third-party autonomous driving module. The electronic device 100 may verify the certificate of the third-party autonomous driving module via a certificate management server. The electronic device 100 may verify the performance of the third-party autonomous driving module via a test scenario, with respect to the third-party autonomous driving module for which the certificate has been verified. Therefore, for convenience of description, herein, the operation of verifying the third-party autonomous driving module may be described as including the operation of verifying the certificate of the third-party autonomous driving module, and the operation of verifying the performance of the third-party autonomous driving module.

The third-party autonomous driving module may not only be connected to a vehicle system, but also, more specifically, may be connected to the electronic device 100. Additionally, the third-party autonomous driving module may be configured to generate command data related to autonomous driving of a vehicle based on data identified from a camera, a radar, and a LiDAR. The third-party autonomous driving module may be configured to generate a control signal related to the command data. The third-party autonomous driving module may transmit the generated control signal to the electronic device 100 and/or the vehicle system.

The certificate may include, for example, information related to authorization for the third-party autonomous driving module to control the vehicle by the certificate management server. In other words, the certificate may include information related to authentication that allows the third-party autonomous driving module to be connected to the vehicle and transmit the control signal related to the autonomous driving to the vehicle by the certificate management server.

The processor 110 may execute software and control at least one other component (e.g., a hardware or software component) connected to the processor 110. Furthermore, the processor 110 may also perform various data processing or operations. For example, the processor 110 may store a software version, identification information, and the certificate in the memory 120.

For reference, the processor 110 may perform all operations performed by the electronic device 100. Therefore, for convenience of description, herein, it is mainly described that the operation performed by the electronic device 100 is the operation performed by the processor 110. Additionally, herein, for convenience of description, the processor 110 is mainly described as being a single processor, but the present disclosure is not limited thereto. For example, the electronic device 100 may include at least one processor. Each of the at least one processor is configured to perform all operations related to the verification of the third-party autonomous driving module.

The memory 120 may temporarily and/or permanently store various data and/or information required to perform all of the operations related to the verification of the third-party autonomous driving module. For example, the memory 120 may store the software version, the identification information, and the certificate.

The communication device 130 may support communication between the electronic device 100 and the certificate management server. For example, the communication device 130 may include one or more components that enable the communication between the electronic device 100 and the certificate management server. For example, the communication device 130 may include a short-range wireless communication device, a microphone, and the like. In this regard, short-range communication technologies may include wireless LAN (Wi-Fi), Bluetooth, ZigBee, Wi-Fi direct (WFD), ultra-wideband (UWB), infrared data association (IrDA), Bluetooth low energy (BLE), Near Field Communication (NFC), and the like, but the present disclosure may not be limited thereto.

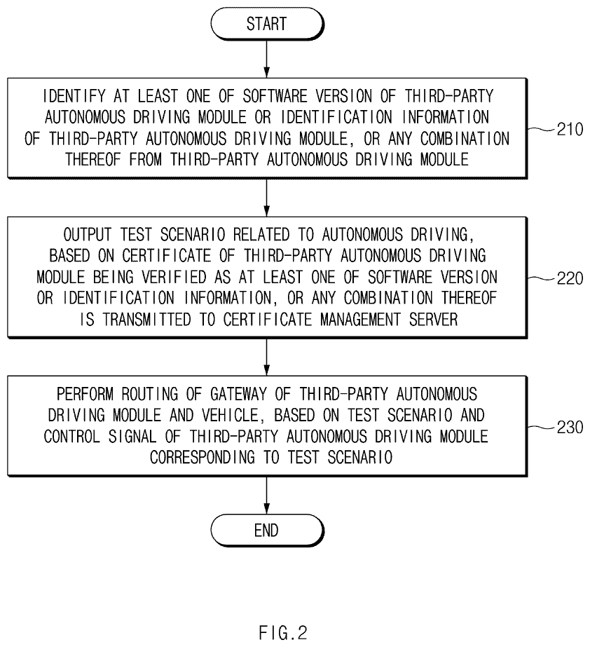

FIG. 2 is a flowchart illustrating a method for verifying a third-party autonomous driving module according to an exemplary embodiment of the present disclosure.

In operation 210, an electronic device (e.g., the electronic device 100 in FIG. 1) according to various exemplary embodiments of the present disclosure may identify at least one of the software version of the third-party autonomous driving module or the identification information of the third-party autonomous driving module, or any combination thereof from the third-party autonomous driving module. For example, the electronic device may identify at least one of the software version or the identification information, or any combination thereof from the third-party autonomous driving module based on the vehicle being connected to the third-party autonomous driving module. In this regard, the connection between the vehicle and the third-party autonomous driving module may be a direct connection between the vehicle and the third-party autonomous driving module or may be an indirect connection therebetween. The direct connection may mean that a data transmission port of the third-party autonomous driving module and a port of the vehicle are directly connected to each other. In contrast, the indirect connection may mean a connection in which data transmitted from the third-party autonomous driving module to a control server is received by the vehicle.

The software version may include, for example, a version of software that runs the third-party autonomous driving module. The identification information may include, for example, information that allows the vehicle to identify the third-party autonomous driving module. The electronic device may identify the software version of the third-party autonomous driving module by identifying the software version. The electronic device may identify the third-party autonomous driving module by identifying the identification information. The electronic device may verify the third-party autonomous driving module for routing of a gateway of the vehicle and the third-party autonomous driving module, based on the identified information.

In operation 220, the electronic device may output the test scenario related to the autonomous driving, based on the certificate of the third-party autonomous driving module being verified as at least one of the software version or the identification information, or any combination thereof is transmitted to the certificate management server. For example, the certificate management server may be a vehicle manufacturer server. The certificate management server may manage the authentication of the third-party autonomous driving module that is configured to perform the autonomous driving of the vehicle. The certificate management server may issue the certificate corresponding to the third-party autonomous driving module. The certificate management server may issue the certificate with respect to the third-party autonomous driving module which may be connected to the vehicle.

The electronic device may be configured to generate the test scenario related to the autonomous driving. For example, the electronic device may perform an operation of controlling the vehicle based on the test scenario while performing a test of the third-party autonomous driving module. The test scenario may include at least one road simulation situation to verify the performance of the third-party autonomous driving module. The electronic device may be provided with at least one test scenario. While performing the test of the third-party autonomous driving module using one test scenario, if it is determined that the ongoing test scenario is not able to be applied because of abnormal driving of the vehicle or the like, the electronic device may use a changed test scenario.

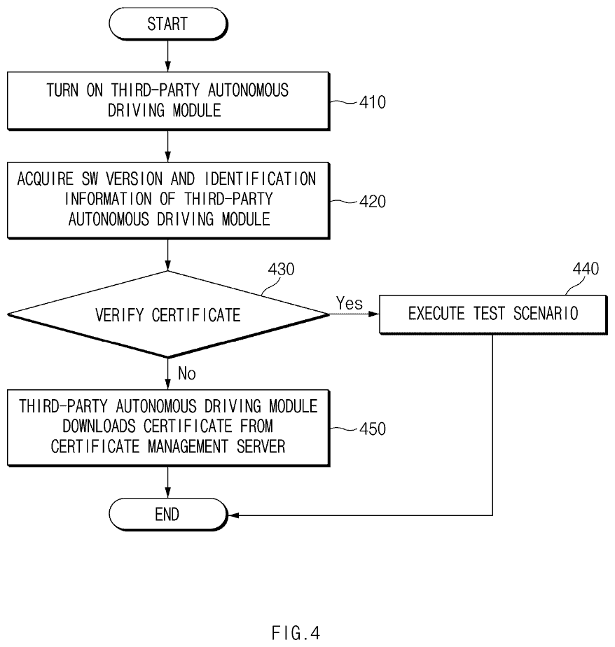

In operation 230, the electronic device may perform the routing of the gateway of the third-party autonomous driving module and the vehicle, based on the test scenario and the control signal of the third-party autonomous driving module corresponding to the test scenario. For example, the electronic device may generate correct answer data for the test scenario. The correct answer data may include a correct answer signal indicating a correct answer to the test scenario while the third-party autonomous driving module is running. The electronic device may receive the control signal from the third-party autonomous driving module. In this regard, the control signal may be an output value of the third-party autonomous driving module for the test scenario. The electronic device may perform the routing of the gateway described above, based on comparison between the correct answer signal and the control signal. A detailed description related thereto will be made later in FIG. 4 below.

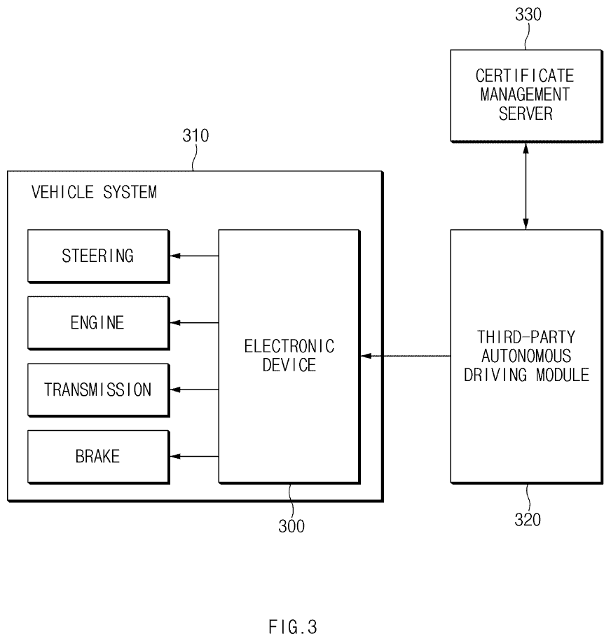

FIG. 3 is a diagram showing a connection relationship with a third-party autonomous driving module of an electronic device according to an exemplary embodiment of the present disclosure.

An electronic device 300 according to various exemplary embodiments of the present disclosure may be included in a vehicle system 310. For example, the electronic device 300 may be included in the vehicle system 310 and transmit the control signal to a steering system, an engine system, a transmission system, and a brake system of the vehicle system 310. In this regard, the control signal transmitted by the electronic device 300 to the vehicle system 310 may represent a control signal obtained from a third-party autonomous driving module 320. That is, the electronic device 300 may obtain the control signal from the third-party autonomous driving module 320 and then transmit the control signal back to the vehicle system 310. A reason for this is as follows. The electronic device 300 may verify the third-party autonomous driving module 320. In other words, the third-party autonomous driving module 320 for which the verification has not been performed may have problems of including a possibility of being hacked from the outside thereof and causing a malfunction of the vehicle. Accordingly, the electronic device 300 may transmit the control signal obtained from the third-party autonomous driving module 320 to the vehicle system 310 after the verification of the third-party autonomous driving module 320 is performed.

The electronic device 300 may obtain the certificate from a certificate management server 330. For example, the electronic device 300 may obtain the certificate from the certificate management server 330 via the third-party autonomous driving module 320. However, the preset disclosure may not be limited thereto, and the electronic device 300 may directly obtain the certificate from the certificate management server 330. Therefore, herein, for convenience of description, the electronic device 300 is described as obtaining the certificate via the third-party autonomous driving module 320.

The third-party autonomous driving module 320 may be connected to each of the electronic device 300 and the certificate management server 330. As described above, connection between the third-party autonomous driving module 320 and the electronic device 300 may include at least one of the direct connection and the indirect connection. Similarly, the connection between the third-party autonomous driving module 320 and the certificate management server 330 may include at least one of the direct connection and the indirect connection.

FIG. 4 is a flowchart illustrating a method for verifying a certificate and executing a test scenario by an electronic device according to an exemplary embodiment of the present disclosure.

An electronic device (e.g., the electronic device 100 in FIG. 1) according to various exemplary embodiments of the present disclosure may apply power to the third-party autonomous driving module in operation 410. For example, the electronic device may apply the power to the third-party autonomous driving module by being connected to the third-party autonomous driving module. The electronic device may apply the power to the third-party autonomous driving module to verify the third-party autonomous driving module.

In operation 420, the electronic device may obtain and/or identify the software version and the identification information of the third-party autonomous driving module. For example, the electronic device may obtain and/or identify at least one of the software version or the identification information, or any combination thereof from the third-party autonomous driving module, based on the vehicle being connected to the third-party autonomous driving module. The electronic device may disconnect the vehicle from the third-party autonomous driving module, based on at least one of the software version or the identification information, or any combination thereof being unidentified. The electronic device is not able to verify the third-party autonomous driving module when at least one of the software version or the identification information, or any combination thereof is not able to be identified.

In operation 430, the electronic device may verify the certificate of the third-party autonomous driving module. For example, the electronic device may obtain a transaction record corresponding to the certificate from a blockchain stored in the certificate management server. The electronic device may verify the certificate based on at least one of the transaction record, the identification information, or model information of the vehicle, or any combination thereof. The electronic device may verify the certificate by verifying at least one of a forgery and alteration record of the certificate or an integrity record of the certificate, or any combination thereof.

In operation 440, the electronic device may execute the test scenario. For example, the electronic device may execute the test scenario by outputting the test scenario to the third-party autonomous driving module. The electronic device may perform following operations to generate the test scenario. The electronic device may identify driving information related to an advanced driver assistance system (ADAS) based on an image, and road information of a predetermined road section. The electronic device may identify a traffic scenario related to the autonomous driving of the vehicle, based on the driving information and the road information. The electronic device may be configured to generate the test scenario based on the driving information, the road information, and the traffic scenario. The electronic device may output the generated test scenario to the third-party autonomous driving module. The electronic device may execute the test scenario by outputting the generated test scenario to the third-party autonomous driving module.

In operation 450, the third-party autonomous driving module may download the certificate from the certificate management server based on the certificate verification being failed. For example, the electronic device may transmit a message related to a certificate issuance request to the third-party autonomous driving module based on the certificate verification being failed. The third-party autonomous driving module may download the certificate from the certificate management server based on the message related to the certificate issuance request described above being received.

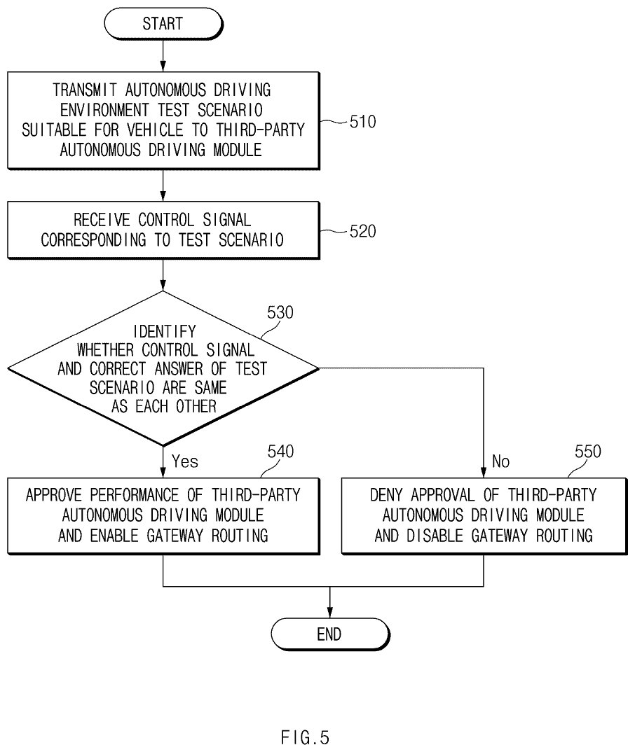

FIG. 5 is a flowchart illustrating a method for performing gateway routing based on a test scenario by an electronic device according to an exemplary embodiment of the present disclosure.

An electronic device (e.g., the electronic device 100 in FIG. 1) according to various exemplary embodiments of the present disclosure may transmit and/or output an autonomous driving environment test scenario suitable for the vehicle to the third-party autonomous driving module in operation 510. For example, the electronic device may execute the test scenario by transmitting and/or outputting the test scenario to the third-party autonomous driving module. The electronic device may transmit and/or output the test scenario generated based on the driving information, the road information, and the traffic scenario to the third-party autonomous driving module.

In operations 520 and 530, the electronic device may receive the control signal corresponding to the test scenario and identify whether the received control signal and the correct answer of the test scenario are the same as each other. For example, the electronic device may generate the correct answer signal related to the test scenario after transmitting and/or outputting the test scenario to the third-party autonomous driving module. The electronic device may obtain result data via comparison between the correct answer signal and the control signal, based on the control signal being received from the third-party autonomous driving module. The electronic device may perform the routing of the gateway of the third-party autonomous driving module and the vehicle, based on the result data and a predetermined threshold value. The electronic device may distinguish between same signals and different signals via the comparison between the correct answer signal and the control signal. The electronic device may obtain the result data including the same signals and the different signals. That is, the electronic device may obtain the result data including one or more same signals and one or more different signals via comparison between a plurality of correct answer signals and a plurality of control signals corresponding thereto.

In operation 540, the electronic device may be configured to determine whether a ratio of the same signals and the different signals included in the result data exceeds the predetermined threshold value. The electronic device may perform the routing of the gateway of the third-party autonomous driving module and the vehicle when the above-mentioned ratio exceeds the predetermined threshold value.

In operation 550, the electronic device may suspend the routing of the gateway of the third-party autonomous driving module and the vehicle based on the result data being below the predetermined threshold value.

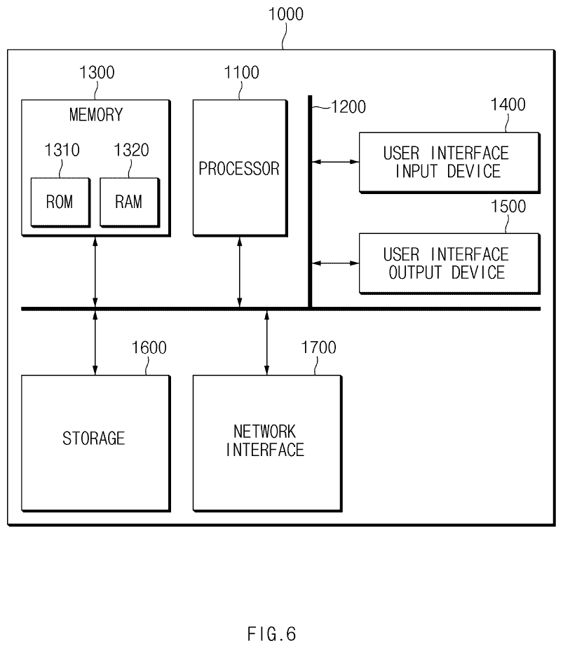

FIG. 6 is a diagram illustrating a computing system related to an electronic device or a control method according to an exemplary embodiment of the present disclosure.

With reference to FIG. 6, a computing system 1000 related to the electronic device or the method may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that is configured to perform processing on commands stored in the memory 1300 and/or the storage 1600. The memory 1300 and the storage 1600 may include various types of volatile or non-volatile storage media. For example, the memory 1300 may include a Read-Only Memory (ROM) and a Random Access Memory (RAM).

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

The exemplary embodiments described above may be implemented with hardware components, software components, and/or a combination of the hardware components and the software components. For example, the device, the method, and the component described in the exemplary embodiments of the present disclosure may be implemented using a general-purpose computer or a special-purpose computer, such as, for example, a processor, a controller, an arithmetic logic unit (ALU), a digital signal processor, a microcomputer, a field programmable gate array (FPGA), a programmable logic unit (PLU), a microprocessor, or any other device which may execute and respond to instructions. A processing device may execute an operating system (OS) and a software application running on the operating system. Additionally, the processing device may access, store, manipulate, process, and generate data in response to execution of software. For case of understanding, the single processing device may be described to be used, but those skilled in the art will appreciate that the processing device may include a plurality of processing elements and/or a plurality of types of processing elements. For example, the processing device may include a plurality of processors or one processor and one controller. Additionally, other processing configurations, such as parallel processors, are possible.

The software may include a computer program, a code, an instruction, or one or more combinations thereof, and may configure the processing device to operate as desired or may independently or collectively instruct the processing device. The software and/or the data may be permanently or temporarily embodied in any type of machine, a component, a physical device, virtual equipment, a computer storage medium or device, or a transmitted signal wave to be interpreted by or to provide instructions or data to the processing device. The software may be distributed over networked computer systems and stored or executed in a distributed manner. The software and the data may be stored on a computer-readable recording medium.

The method according to the exemplary embodiment of the present disclosure may be implemented in a form of program instructions which may be executed via various computer means and recorded on a computer-readable medium. The computer-readable medium may include the program instruction, a data file, a data structure, and the like singly or in combination, and the program instruction recorded on the medium may be specially designed and configured for the exemplary embodiment or may be known and available to those skilled in the art of the computer software. Examples of the computer-readable recording media include magnetic media such as a hard disk, a floppy disk, and a magnetic tape, optical media such as a CD-ROM and a DVD, magneto-optical media such as a floptical disk, and hardware devices specifically configured to store and execute the program instructions such as a ROM, a RAM, and a flash memory. Examples of the program instructions include machine language code, such as that produced by a compiler, as well as high-level language code which may be executed by a computer using an interpreter or the like.

The hardware device described above may be configured to operate as one or a plurality of software modules to perform the operation of the exemplary embodiment of the present disclosure, and vice versa.

Although the exemplary embodiments are described with limited drawings as described above, those skilled in the art may apply various technical modifications and variations based on the same. For example, even if the described technologies are performed in an order different from that in the described method, and/or components of the described system, structure, device, circuit, and the like are coupled or combined with each other in a form different from that in the described method, or are replaced with or substituted by equivalents, appropriate results may be achieved.

Therefore, other implementations, other embodiments, and equivalents of the claims also fall within the scope of the claims described below.

Therefore, the exemplary embodiments included in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

Effects of the electronic device and the control method according to an exemplary embodiment of the present disclosure will be described as follows.

According to at least one of the exemplary embodiments of the present disclosure, the pre-authorized third-party autonomous driving module may be used and the failure and the malfunction of the vehicle caused by the third-party autonomous driving module may be prevented by identifying the software version and the identification information from the third-party autonomous driving module and verifying the certificate via the certificate management server.

Furthermore, according to at least one of the exemplary embodiments of the present disclosure, the routing of the gateway of the third-party autonomous driving module that has been authorized in advance and whose autonomous driving performance has been verified and the vehicle may be performed by comparing the test scenario with the control signal of the third-party autonomous driving module based on the certificate being verified.

Furthermore, various effects that are directly or indirectly identified through the present specification may be provided.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An electronic apparatus comprising:
a memory configured to store computer-executable instructions; and
at least one processor configured to access the memory and execute the instructions,
wherein the at least one processor is configured to:
identify, from a third-party autonomous driving module, at least one of a software version of the third-party autonomous driving module or identification information of the third-party autonomous driving module, or any combination thereof;
output a test scenario related to autonomous driving based on a certificate of the third-party autonomous driving module being verified as at least one of the software version or the identification information, or any combination thereof is transmitted to a certificate management server; and
perform routing of a gateway of the third-party autonomous driving module and a vehicle based on the test scenario and a control signal of the third-party autonomous driving module corresponding to the test scenario.

2. The electronic apparatus of claim 1, wherein the at least one processor is further configured to:
identify at least one of the software version or the identification information, or any combination thereof from the third-party autonomous driving module based on the vehicle and the third-party autonomous driving module being connected to each other; and
disconnect the vehicle and the third-party autonomous driving module from each other based on at least one of the software version or the identification information, or any combination thereof not being identified.

3. The electronic apparatus of claim 1, wherein the at least one processor is configured to transmit a message related to a certificate issuance request to the third-party autonomous driving module based on the verification of the certificate being failed.

4. The electronic apparatus of claim 1, wherein the at least one processor is further configured to:
obtain a transaction record corresponding to the certificate from a blockchain stored in the certificate management server; and
verify the certificate based on at least one of the transaction record, the identification information, or a model information of the vehicle, or any combination thereof.

5. The electronic apparatus of claim 1, wherein the at least one processor is further configured to:
identify driving information related to an image-based advanced driver assistance system (ADAS) and road information of a predetermined road section;
identify a traffic scenario related to the autonomous driving of the vehicle based on the driving information and the road information;
generate the test scenario based on the driving information, the road information, and the traffic scenario; and
output the test scenario to the third-party autonomous driving module.

6. The electronic apparatus of claim 1, wherein the at least one processor is further configured to:
generate a correct answer signal for the test scenario;
obtain result data via comparison between the correct answer signal and the control signal based on the control signal being received from the third-party autonomous driving module; and
perform the routing of the gateway of the third-party autonomous driving module and the vehicle based on the result data and a predetermined threshold value.

7. The electronic apparatus of claim 6, wherein the at least one processor is further configured to stop the routing of the gateway of the third-party autonomous driving module and the vehicle based on the result data being smaller than the predetermined threshold value.

8. The electronic apparatus of claim 1,
wherein the software version includes a version of software running the third-party autonomous driving module,
wherein the identification information includes information allowing the vehicle to identify the third-party autonomous driving module, and
wherein the certificate includes information on authorization for the third-party autonomous driving module to control the vehicle by the certificate management server.

9. A control method comprising:
identifying by at least one processor, from a third-party autonomous driving module, at least one of a software version of the third-party autonomous driving module or identification information of the third-party autonomous driving module, or any combination thereof;
outputting, by the at least one processor, a test scenario related to autonomous driving based on a certificate of the third-party autonomous driving module being verified as at least one of the software version or the identification information, or any combination thereof is transmitted to a certificate management server; and
performing, by the at least one processor, routing of a gateway of the third-party autonomous driving module and the vehicle based on the test scenario and a control signal of the third-party autonomous driving module corresponding to the test scenario.

10. The control method of claim 9, wherein the identifying of the at least one of the software version or the identification information, or any combination thereof includes:
identifying at least one of the software version or the identification information, or any combination thereof from the third-party autonomous driving module based on the vehicle and the third-party autonomous driving module being connected to each other; and
disconnecting the vehicle and the third-party autonomous driving module from each other based on at least one of the software version or the identification information, or any combination thereof not being identified.

11. The control method of claim 9, wherein the outputting of the test scenario related to the autonomous driving includes:
transmitting a message related to a certificate issuance request to the third-party autonomous driving module based on the verification of the certificate being failed.

12. The control method of claim 9, wherein the outputting of the test scenario related to the autonomous driving includes:
obtaining a transaction record corresponding to the certificate from a blockchain stored in the certificate management server; and
verifying the certificate based on at least one of the transaction record, the identification information, or a model information of the vehicle, or any combination thereof.

13. The control method of claim 9, wherein the outputting of the test scenario related to the autonomous driving includes:
identifying driving information related to an image-based advanced driver assistance system (ADAS) and road information of a predetermined road section;
identifying a traffic scenario related to the autonomous driving of the vehicle based on the driving information and the road information;
generating the test scenario based on the driving information, the road information, and the traffic scenario; and
outputting the test scenario to the third-party autonomous driving module.

14. The control method of claim 9, wherein the performing of the routing of the gateway of the third-party autonomous driving module and the vehicle includes:
generating a correct answer signal for the test scenario;
obtaining result data via comparison between the correct answer signal and the control signal based on the control signal being received from the third-party autonomous driving module; and
performing the routing of the gateway of the third-party autonomous driving module and the vehicle based on the result data and a predetermined threshold value.

15. The control method of claim 9, wherein the performing of the routing of the gateway of the third-party autonomous driving module and the vehicle includes:
stopping the routing of the gateway of the third-party autonomous driving module and the vehicle based on the result data being smaller than the predetermined threshold value.

16. The control method of claim 9, wherein the software version includes a version of software running the third-party autonomous driving module,
wherein the identification information includes information allowing the vehicle to identify the third-party autonomous driving module,
wherein the certificate includes information on authorization for the third-party autonomous driving module to control the vehicle by the certificate management server.
